(19) United States
(12) Patent Application Publication
(10) Pub. No.: US 2014/0258880 A1
(43) Pub. Date: Sep. 11, 2014

(54) METHOD AND APPARATUS FOR GESTURE-BASED INTERACTION WITH DEVICES AND TRANSFERRING OF CONTENTS

(71) Applicant: NOKIA CORPORATION, Espoo (FI)

(72) Inventors: Jukka Holm, Tampere (FI); Juha Arrasvuori, Tampere (FI)

(73) Assignee: Nokia Corporation, Espoo (FI)

(21) Appl. No.: 13/788,635

(22) Filed: Mar. 7, 2013

(51) Int. Cl. H04L 29/06

(52) U.S. Cl. CPC H04L 65/40
USPC 715/748

(57) ABSTRACT

An approach is provided for enabling gesture-based interaction with devices and transferring of contents. A device may process and/or facilitate a processing of one or more interactions with at least one first device to cause, at least in part, a selection of at least one content item, one or more information items associated with the at least one content item, or a combination thereof associated with the at least one first device. The device may further process and/or facilitate a processing of the one or more interactions, one or more other interactions with at least one second device, or a combination thereof to cause, at least in part, a selection of the at least one second device. Additionally, the device may cause, at least in part, a transfer of the at least one content item, the one or more information items associated with the at least one content item, or a combination thereof to the at least one second device.

### BACKGROUND

Service providers are continually challenged to deliver value and convenience to consumers by providing compelling network services and advancing the underlying technologies. Some users may acquire and utilize multiple devices; for example, mobile phones, tablets, laptop computers, gaming systems, digital television (TV) sets, and the like, to access and consume a wide range of contents and information for various tasks and entertainment. However, at times, the users may be consuming and/or interacting with various contents and associated information on one device, where it may be more desirable to consume and/or interact with the content and the information on another nearby device. For example, a user may be viewing an image and information associated with a content item (e.g., a car) presented on a TV set, but he may wish to use another nearby device to interact with the content item and/or obtain more information about it, for example, from an Internet site. However, transferring the content item and any associated information from a first device to a second device may require for the user to manually note and enter the information presented on the first device onto the second device, wherein the manual process may be time consuming and inaccurate where the user may forgo the process.

### SOME EXAMPLE EMBODIMENTS

Therefore, there is a need for an approach for gesture-based interaction with devices and transferring of contents.

According to one embodiment, a method comprises processing and/or facilitating a processing of one or more interactions with at least one first device to cause, at least in part, a selection of at least one content item, one or more information items associated with the at least one content item, or a combination thereof associated with the at least one first device. The method also comprises processing and/or facilitating a processing of the one or more interactions, one or more other interactions with at least one second device, or a combination thereof to cause, at least in part, a selection of the at least one second device. The method further comprises causing, at least in part, a transfer of the at least one content item, the one or more information items associated with the at least one content item, or a combination thereof to the at least one second device.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of one or more interactions with at least one first device to cause, at least in part, a selection of at least one content item, one or more information items associated with the at least one content item, or a combination thereof associated with the at least one first device. The apparatus is also caused to process and/or facilitate a processing of the one or more interactions, one or more other interactions with at least one second device, or a combination thereof to cause, at least in part, a selection of the at least one second device. The apparatus is further caused to cause, at least in part, a transfer of the at least one content item, the one or more information items associated with the at least one content item, or a combination thereof to the at least one second device.

According to another embodiment, a computer-readable storage medium carries one or more sequences of one or more instructions which, when executed by one or more processors, cause, at least in part, an apparatus to process and/or facilitate a processing of one or more interactions with at least one first device to cause, at least in part, a selection of at least one content item, one or more information items associated with the at least one content item, or a combination thereof associated with the at least one first device. The apparatus is also caused to process and/or facilitate a processing of the one or more interactions, one or more other interactions with at least one second device, or a combination thereof to cause, at least in part, a selection of the at least one second device. The apparatus is further caused to cause, at least in part, a transfer of the at least one content item, the one or more information items associated with the at least one content item, or a combination thereof to the at least one second device.

According to another embodiment, an apparatus comprises means for processing and/or facilitating a processing of one or more interactions with at least one first device to cause, at least in part, a selection of at least one content item, one or more information items associated with the at least one content item, or a combination thereof associated with the at least one first device. The apparatus also comprises means for processing and/or facilitating a processing of the one or more interactions, one or more other interactions with at least one second device, or a combination thereof to cause, at least in part, a selection of the at least one second device. The apparatus further comprises means for causing, at least in part, a transfer of the at least one content item, the one or more information items associated with the at least one content item, or a combination thereof to the at least one second device.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling gesture-based interaction with devices and transferring of contents, according to an embodiment;

FIG. 2 is a diagram of the components of a processing platform, according to an embodiment;

FIG. 3 is a diagram of the components of a user equipment capable of gesture-based interaction with devices and transferring of contents among a plurality of devices, according to an embodiment;

FIGS. 4 and 5 illustrate flowcharts of various processes for, at least, a user gesture-based interaction with devices and transferring of contents among a plurality of devices, according to various embodiments;

FIG. 6 illustrates various devices for detecting sensory data, according to an embodiment;

FIG. 7 illustrates example user gestures for interacting with various devices, according to various embodiments;

FIGS. 8A through 8C illustrate various user gesture-based interactions with various devices and contents presented on various devices, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for enabling gesture-based interaction with devices and transferring of contents. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to transferring content and information among a plurality of devices within close proximity to each other, it is contemplated that the approach described herein may be used with remote, local, and/or virtual devices. Further, the interaction may be via touch or proximity based interfacing, device sensing, short range detection, point-to-point connection, virtual interfacing, ad-hoc networking, and the like.

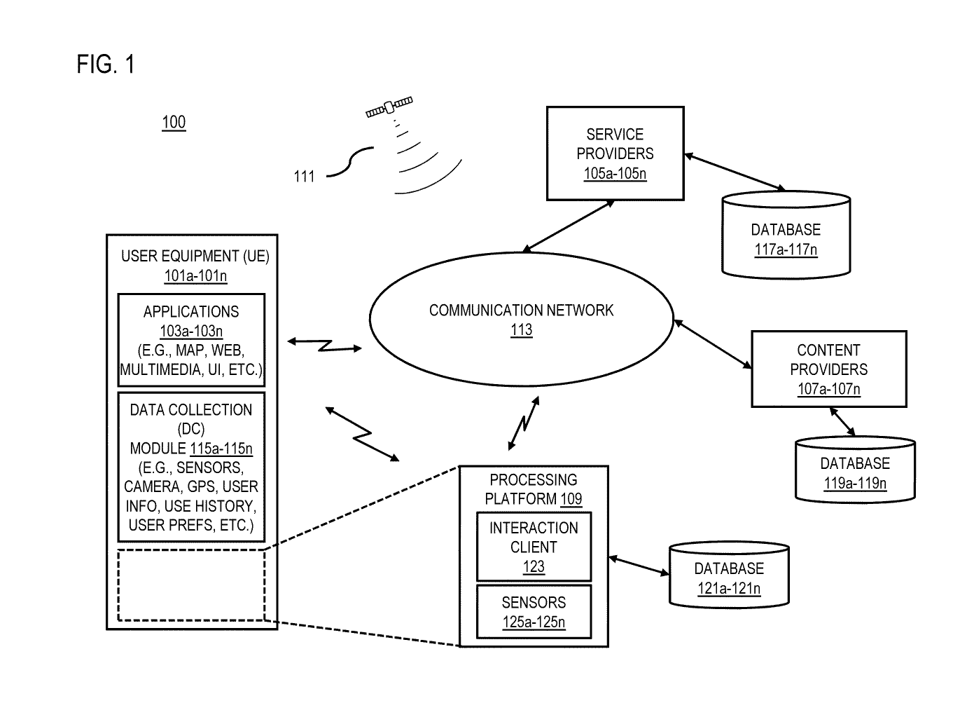

FIG. 1 is a diagram of a system capable of enabling gesture-based interaction with devices and transferring of contents, according to an embodiment. As discussed above, with proliferation of users utilizing a plurality of devices for various tasks and infotainment, at times, users may wish to transfer consumption of various contents and associated information from one device to one or more other devices. For example, a user may be watching a presentation of contents and various associated information (e.g., a Web link, product information, etc.) on a TV set when the user notices a certain content item and wishes to transfer the content item and/or its associated information from the TV set to a nearby tablet. In one example, a user may wish to access information on a content item that may be presented on a first UE 101 (e.g., a TV set), however, noting the information about the content item for accessing information on a second UE 101 may be inefficient, time consuming, and inaccurate where the user may not have enough time to capture the information presented on the first UE 101. Further, the contents presented on the first UE 101 may not be presented long enough for the user to note and use any associated information. Furthermore, a user may not be able to easily and efficiently interact with the first device and a second device to capture and utilize any contents and/or information of interest.

To address, at least problems, a system 100 of FIG. 1 introduces the capability for gesture-based interaction with devices and transferring of contents. Traditionally, users interact with user devices, for example, a TV set, a computer display, and tablet, and the like via various user interfaces on a given device where the user may utilize a physical interface at the device to select, highlight, enter, etc. various contents (e.g., music files, video files, documents, applications) on the device. However, with proliferation of number of devices that a user may utilize and/or have access to, a user may not be able to quickly and efficiently interact with numerous devices at for selecting, transferring, and consuming contents via the numerous devices.

In one use case scenario, a user may be watching a TV shopping channel that presents various contents and items, where the user makes a gesture by his hand (e.g., in the air) to point to an area on the TV display to highlight and select an item presented thereon. In one embodiment, one or more sensors on the TV set and/or another device may determine the area on the TV that the user is pointing to and the contents at may be within that area. Further, while the content is selected and highlighted, the user may interact with one or more other devices (e.g., a mobile phone, a tablet, etc.) to select one or more other devices so that the selected contents may be transferred from the TV set to the one or more other devices. In one embodiment, the contents may be transferred from the TV set to one or more other device via one or more communication channels, for example, one or more proximity-based (e.g., Bluetooth®, WLAN, etc.) and/or network-based (e.g., cellular) communication channels. In one example, the content may be an image of the content item. In one example, the content may include one or more information items (e.g., textual.) In one embodiment, the user may utilize the content item and any associated information items to access additional information via one or more service and/or content providers. In one use case scenario, the user may collect multiple content items in a shopping basket on the second device so that he may access and process the contents via one or more applications, service and/or content providers. In various examples, the user may manipulate, edit, view, and the like the content item on a second user device.

In one use case scenario, a user may be watching an interactive program (e.g., cartoon) on the first display, wherein the first display may detect one or more gestures by the user for selecting an area from the program by pointing at the first display and drawing a circle in the air. Further, the user may interact may interact with a second device, for example, to touch the display of a second device for selecting the second device. Furthermore, the selected area on the first display is then transferred to the second device, wherein the user may interact with the transferred contents, for example, via a hover-sensing equipped touch display of the second device. In one embodiment, any edits/changes on the content item done via the second device may be updated and presented in real-time onto the first display. In one use case scenario, the system 100 may have access to one or more user's previous content consumption history.

In one use case scenario, a user may utilize an electronic program guide (EPG) on a firs device and on a nearby second device by making a predefined gesture, where the user may utilize the second device (e.g., a tablet) and gesture and/or make a swipe on screen of the second device (e.g., left/right) to switch between program and presentations on the first device. In one embodiment, if a program and/or a presentation is similar to a user preference or user history (e.g., during that day, or week, etc.), then the second device may provide a haptic feedback to the user. In one embodiment, the system 100 may cause one or more bookmarks of one or more programs, presentations, contents, and the like at the first device and/or one or more other devices associated with a user profile and/or user preference.

In one use case scenario, a group of users may be attending an event (e.g., a party at someone's home) where various contents (e.g., multimedia, music, video, etc.) may be presented on one or more devices (e.g., a large monitor.) For example, a larger display (e.g., a TV set) may be used to show names of currently playing song/artist/album, album front cover, and other selected information, where the display may easily be visible to people attending the event. In one use case scenario, if a user is interested in a currently presented content item, then the user may make a gesture to “grab” the content item (e.g., a song/audio file) from the large display and transfer it to a user device (e.g., a tablet) for further detailed viewing, interaction, inspection, and the like. For example, the user device may show additional information, pictures, etc. of an artist and a detailed artist biography associated with a content item. In one embodiment, the user may store/send/associate the content to one or more user social networking accounts. In one example, the user device may also be used for searching more content, for example songs, from same artist or similar type of contents. In one embodiment, contents (e.g., new/other album tracks) may be transferred (e.g., “thrown”) from the user device to the playlist playing on the larger display.

In one embodiment, a user, a device manufacturer, a service provider, a content provider, and the like may cause to associate (e.g., by default) one or more applications and/or content types with one or more service providers and/or one or more content providers. For example, when a content item is transferred to a device, an application on the device may cause launching of an Internet application to search (e.g., via a service provider, a search engine, etc.) for additional information related to the content item. In one example, an application may direct a user to a certain Internet shopping site where the content item and/or similar contents may be available to users.

As shown in FIG. 1, in one embodiment, the system 100 includes user equipment (UE) 101a-101n (also collectively referred to as a UE 101 and/or UEs 101), which may be utilized to execute one or more applications 103a-103n (also collectively referred to as applications 103) including navigation application, jobs near me, games, social networking, web browser, media application, user interface (UI), map application, web client, etc. to communicate with other UEs 101, one or more service providers 105a-105n (also collectively referred to as service provider/providers 105), one or more content providers 107a-107n (also collectively referred to as content provider/providers 107), a processing platform 109, one or more satellites 111a-111n (also collectively referred to as the satellite system 111), and/or with other components of a the system 100 directly and/or over a communication network 113. In one embodiment, the UEs 101 may include data collection modules 115a-115n (also collectively referred to as DC module 115) for determining and/or collecting data associated with the UEs 101, one or more sensors of the UE 101, one or more users of the UEs 101, applications 103, one or more content items, and the like.

In one embodiment, the service providers 105 may include and/or have access to one or more databases 117a-117n (also collectively referred to as database 117), which may include various mapping data, user information, user profiles, user preferences, one or more profiles of one or more user devices (e.g., device configuration, sensors information, etc.), information on the service providers 105, and the like. In one embodiment, the service providers 105 may include one or more service providers offering one or more services, for example, location based services, online shopping, social networking services (e.g., blogging), content sharing, media upload, media download, media streaming, account management services, or a combination thereof. Further, the service providers 105 may conduct a search for content items, media items, information, product and/or service information, coupons, and the like associated with one or more users, content items, POIs, geo-locations, and the like.

In one embodiment, the content providers 107 may include and/or have access to one or more database 119a-119n (also collectively referred to as database 119), which may store, include, and/or have access to various content items. For example, the content providers 107 may store content items (e.g., at the database 119) provided by various users, various service providers, crowd-sourced content, and the like. Further, the service providers 105 and/or the content providers 107 may utilize one or more service application programming interfaces (APIs)/integrated interface, through which communication, media, content, and information (e.g., associated with users, applications, services, contents, etc.) may be shared, accessed and/or processed.

In one embodiment, the processing platform 109 may include and/or have access to one or more database 121a-121n (also collectively referred to as database 121), which may store, include, and/or have access to various data, for example, from different sources and/or different time periods, user information, device information, contents, service provider information, and the like. In one embodiment, one or more portions of the processing platform may be implemented in a UE 101, for example, in a TV set, in a computer, in a gaming console, in a tablet, and the like. In certain embodiments, the a processing platform 109 may be configured for operation by a device to enable users to use gestures and/or motions (e.g., hand, finger, facial, etc.) for interacting with one or more devices for requesting and/or transferring content among a plurality of devices. By way of example, the processing platform 109 is presented as a component operable for direct execution by a device, i.e., a UE 101. Under this approach, the processing platform 109 may be implemented as a software executable, hardware executable, or a combination thereof. Alternatively, the processing platform 109 may be accessed via a communication network 113 as a service or a platform. In either implementation, the processing platform 109 is configured to, at least, facilitate a gesture-based interface for transferring contents and information among a plurality of devices.

Further, the processing platform 109 may include various mechanisms for detecting, capturing, and processing one or more gestures made by one or more users. In one scenario, the processing platform 109 may utilize a plurality of sensors; for example, cameras, microphones, infrared (IR), motion, and the like sensors to detect, capture, and process the gestures. In one example, a user may make the gestures by moving an object, hands, fingers, facial expressions, and the like. Furthermore, the processing platform 109 and/or the database 121 may be partially or completely implemented within one or more devices (e.g., a TV set, an electronic display, etc.), one or more modules, one or more architectures, and the like. In various embodiments, the processing platform 109 may determine one or more executable commands based on one or more gestures by one or more users, wherein the commands may be associated with determining and transferring various contents and information among a plurality of devices. In various embodiments, the processing platform 109 may be maintained on a network server and include a web-service, an applet, a script, an object-oriented application, and the like while operating in connection with one or more sensors and/or devices in a user environment. In one embodiment, the processing platform 109 may process contextual information associated with contents and/or information presented at a device, wherein one or more service and/or content providers may be determined from the contextual information.

In one embodiment, the processing platform 109 may include an interaction client 123, which may perform one or more steps for detecting, capturing, and/or processing the one or more gestures made by one or more users for interacting with one or more devices, contents, and/or information presented at one or more devices. In one embodiment, the processing platform 109 may include one or more sensors 125a-125n (also collectively referred to as sensors 125), for example, two-dimensional (2D) or three-dimensional (3D) cameras (e.g., for image/gesture detection), microphones (e.g., for voice commands), Bluetooth®, WLAN, near field communications (NFC), radio frequency identification (RFID), IR, and the like. In one embodiment, the processing platform 109 may detect presence of one or more users and/or one or more devices in close proximity. In one embodiment, the sensors 125 may be partially or completely integrated with the processing platform 109 or the sensors 125 may be implemented as one or more modules external to the processing platform 109. For example, a plurality of cameras and microphones may be installed in a room (e.g., on the ceiling, on the walls, etc.) where they may communicate with the processing platform 109 and/or nearby UEs 101. In various embodiments, the UEs 101 and the sensors 125 may include a combination of various sensors, for example, one or more wearable sensors, accelerometers, physiological sensors, biometric sensors, location sensors, and the like. By way of example, connectivity between the UEs 101, the processing platform 109, and the sensors 125 may be facilitated by short range wireless communications (e.g., Bluetooth®, WLAN, ANT/ANT+, ZigBee, etc.) In various embodiments, the sensors 125 may include one or more stationary sensors in a spatial proximity to the user (e.g., a camera installed in an office space) and/or may be mobile (e.g., may follow a user's movements).

In one embodiment, the UEs 101 may include one or more portions of the processing platform 109, for example the interaction client 123, to perform one or more process steps for detecting, capturing, and/or processing the one or more gestures made by one or more users for interacting with one or more devices, contents, and/or information presented at one or more devices. In addition, the UEs 101 can execute the applications 103 that as a software client for storing, processing, and/or forwarding collected sensor data to other components of the system 100. In one embodiment, the system 100 processes and/or facilitates a processing of sensor data associated with at least one user to determine one or more activities. In various embodiments, a user may utilize one or more user devices (e.g., a personal computer, a mobile phone, a tablet, etc.), which may include various sensors (e.g., audio, video, image, GPS, accelerometer, etc.) for capturing and determining information about the user, the UEs 101, and/or environment of the user and/or the UEs 101. For example, the sensors may capture an image and/or audio sample of the user and utilize one or more activity recognition algorithms to determine if the user is sitting, speaking, walking, looking at a computer monitor, typing at the computer keyboard, looking at a certain direction, user gestures, facial expressions of the user, and the like.

In one embodiment, the system 100 processes and/or facilitates a processing of one or more interactions with at least one first device to cause, at least in part, a selection of at least one content item, one or more information items associated with the at least one content item, or a combination thereof associated with the at least one first device. In one embodiment, the one or more interactions, the one or more other interactions, or a combination thereof include, at least in part, one or more gesture-based interactions. In one embodiment, a first UE 101 may include and utilize one or more sensors (e.g., camera, microphones, IR, etc.) to detect one or more gestures from one or more users in proximity of the UE 101. For example, a TV set may include a camera (e.g., forward looking, on the same side as the display), which can detect movements, hand gestures, facial impressions, and the like of a nearby user, which may be interacting with the TV set. Further, the UE 101 may determine from the user gestures, for example, that the user is pointing to a certain location on the display of the UE 101. For example, the UE 101 may utilize imaging data (e.g., in x-y-z coordinates) from the camera to determine location of the user in a room and further translate and determine where on the TV display is the user pointing to as a selection area. Furthermore, the UE 101 may determine contents that may be displayed in the selection area on the UE 101 display. For example, the user may be pointing to an image of a car displayed on the TV where the user pointed at for selecting the image of the car as a selected content item. In various embodiments, one or more UEs 101, one or more sensors, one or more other systems, and the like may function and interact together to capture and determine the imaging data, the location data, the user gestures, user movements, and the like. In one embodiment, the system 100 may substantially simultaneously determine one or more simultaneous gestures and interactions from one or a plurality of users. In one embodiment, the system 100 may substantially simultaneously determine a first gesture for interaction with a first device and one or more other gestures for interaction with one or more other devices. For example, a first UE 101 may determine a gesture by a user where the user interacts with the first UE 101, and a second UE 101 may determine a simultaneous second gesture by the user for interacting with the second device. In one example, the first device may determine a simultaneous first gesture (e.g., by the user's left hand) and a second gesture (e.g., by the user's right hand), where the first gesture may be to interact with the first device for selecting a content item therein and the second gesture may be to transfer the selected content item to a second device. In one embodiment, the system 100 may substantially simultaneously determine a plurality of simultaneous gestures by a plurality of users for interacting with a plurality of devices.

In one embodiment, the system 100 processes and/or facilitates a processing of the one or more interactions, one or more other interactions with at least one second device, or a combination thereof to cause, at least in part, a selection of the at least one second device. In one embodiment, one or more second UEs 101 may utilize one or more sensors to detect and determine one or more gestures of a user for selecting and/or interacting with the one or more second UEs 101. For example, a second UE 101 may utilize an onboard camera sensor to detect a gesture by a nearby user, which may indicate that the user wishes to select and interact with the second UE 101. In various examples, the user may use his hands and/or objects, to point, wave, make a grabbing gesture, make a fist, and the like, wherein each gesture may be detected by the system 100, which may determine that each gesture may represent one or more commands and/or action requests. In one embodiment, one or more other UEs 101 and/or sensors may detect and determine that the user is intending to select and interact with the second UE 101, wherein the other UEs 101 and/or sensors may communicate that information to the second UE 101. For example, a wall-mounted camera in a room may detect that a user is pointing to a nearby tablet device (e.g., on a coffee table), where the camera may transmit one or more messages to the tablet device indicating that the user is pointing to the tablet device.

In one embodiment, the system 100 causes, at least in part, a transfer of the at least one content item, the one or more information items associated with the at least one content item, or a combination thereof to the at least one second device. In one embodiment, a first UE 101 may determine that a user utilizes gestures (e.g., moving/pointing hand, finger, an object, a UE 101, etc.) to point to and select a content item presented on a display of a UE 101, wherein the user wishes to transfer the content item and/or information related to the content item to a second UE 101. In one embodiment, the first UE 101 may cause the transfer of the content item and/or the information to the second UE 101. In one embodiment, the user identifies the second UE 101 via one or more gestures and/or interactions with the first and/or the second UE 101. In one embodiment, the transfer is via one or more proximity communication channels, one or more network based communication channels, or a combination thereof. In various embodiments, the system 100 may utilize one or more communication channels for transferring the content and/or the information from a first device to one or more other devices, wherein the communication channels may include one or more proximity-based (e.g., device-to-device) and/or network-based channels.

In one embodiment, the system 100 determines the at least one second device based, at least in part, on a proximity to the at least one first device. In one embodiment, one or more devices may determine presence of one or more other near-by devices via one or more proximity-based sensors (e.g., Bluetooth®, WLAN, etc.) and/or based on location information (e.g., GPS) of a device via a network service provider. For example, a first UE 101 may establish a proximity-based network (e.g., WLAN, Bluetooth®, etc.) in a room where other UEs 101 may join the network.

In one embodiment, the system 100 causes, at least in part, one or more actions at the at least one first device based, at least in part, on the one or more interactions with the at least one first device. In one embodiment, a UE 101 may determine to perform one or more actions based on one or more interactions caused by one or more users. For example, a UE 101 may cause execution of one or more applications on the UE 101 based on a gesture by a user. In one embodiment, a UE 101 may cause a selection (e.g., highlight) of contents, for example, information, images, videos, files, Internet links, and the like.

In one embodiment, the system 100 determines the one or more interactions, the one or more other interactions, or a combination thereof based, at least in part, on one or more sensors associated with the at least one first device, the at least one second device, at least one third device, or a combination thereof. In various embodiments, the UEs 101 may include various sensors, for example, cameras, microphones, IR detectors, electric field sensing, light detectors, and the like. In one embodiment, the at least one third device is associated with a spatial environment of the at least one first device, the at least one second device, or a combination thereof. In one instance, a first UE 101 and a second UE 101 may interact via one or more other devices (e.g., a third device), wherein the one or more other devices may be stationary and/or mobile devices in an area nearby to the first and/or the second UEs 101.

In one embodiment, the system 100 causes, at least in part, one or more actions at the at least one first device based, at least in part, on one or more interactions with the at least one second device. In one embodiment, a user may utilize a first UE 101 to interact with a second UE 101, wherein one or more actions on the first device may cause one or more actions on the second device. For example, a user may use a first UE 101 to control functions, programs, and applications on a second UE 101 (e.g., a TV set), wherein the UE 101 may provide various information associated with programs, applications, and functions available on the TV set.

In one embodiment, the system 100 causes, at least in part, one or more actions at the at least second device based, at least in part, on the at least one content item, the one or more information items, a user input, or a combination thereof. In one embodiment, a UE 101 which receives contents and information may cause execution of one or more applications that may be available locally on the UE 101 or available from a remote source (e.g., a service provider, a server, another UE 101, etc.) so that a user of the UE 101 may consume/utilize the content and/or the information. In one embodiment, the user may configure the UE 101 as to what applications may be utilized based on a content type. For example, if the content includes an Internet link, then a web browsing application may be executed to follow the link to a web target. In one embodiment, a UE 101, for example a first and/or a second device, may analyze the content to determine one or more suitable applications for a user to utilize, access, and/or consume the contents. For example, a second device receiving a content item may analyze the content to determine that the content is an image file, which may be viewed, edited, manipulated, etc. by one or more applications that may be available on the second device, via a service provider, and the like. In one embodiment, the UE 101 may receive the contents that include metadata which may indicate one or more applications and/or programs for use to consume the contents. In one embodiment, a UE 101 may cause to store the contents at a local and/or remote (e.g., cloud) storage device.

In one embodiment, the system 100 processes and/or facilitates a processing of one or more interactions with the at least one second device to cause, at least in part, a selection of the at least one content item, the one or more information items associated with the at least one content item, or a combination thereof associated with the at least one second device. In one scenario, a user may interact with a second UE 101 (e.g., a tablet) to select and utilize one or more contents, for example, a user may modify, manipulate, consume, edit, etc. contents on the UE 101. In one embodiment, a UE 101 may detect a single gesture for interacting with the second device. In one embodiment, the gesture may include one or more gesture elements for interacting with one or more contents and/or devices.

In one embodiment, the system 100 causes, at least in part, a transfer of the at least one content item, the one or more information items associated with the at least one content item, or a combination thereof to the at least one first device. In one embodiment, a user may interact with the second UE 101 to select and transfer contents from the second UE 101 to one or more other UEs 101 (e.g., a TV set) wherein the contents may be available at the second UEs 101 and/or at a remote device (e.g., cloud storage site.) In one embodiment, the contents may be contents that the second UE 101 had received from a first UE 101, which the user of the second device may have utilized, consumed, edited, and the like.

In various embodiments and use case scenarios, a user may employ natural gestures to interact with various devices for contents thereon where flexible, efficient and interesting input methods (e.g., hover sensor, gestures in the air, etc.) may be used to interact and transfer the contents from one device to another. Further, various applications on the devices may facilitate transfer, collection, aggregation, storage, and consumption of the contents via a wide range of user devices and service/content providers, for example, device manufacturers, online shopping, media content, advertisement, etc.

In one embodiment, a user may wear one or more sensors (e.g., a microphone, a camera, an accelerometer, etc.) for monitoring and collection of sensor data (e.g., images, audio, gestures, movements, etc.) For example, the sensors may capture accelerometer, image, and audio information at periodic intervals. The UEs 101 (e.g., via the application 103 and/or the DC module 115 may store the data temporarily, perform any needed processing and/or aggregation, and send the data to the processing platform 109. By way of example, the operational states of the sensors on the UEs 101 and/or at the processing platform 109 may include settings and/or configuration parameters including sampling rate, parameters to sample, transmission protocol, activity timing, etc. By way of example, the UEs 101 and/or the processing platform 109 may include one or more components for providing adaptive filtering of the sensors and/or the sensor data.

In one embodiment, the UE 101 includes a location module/sensor that can determine the UE 101 location (e.g., a user's indoor/outdoor location). The UE 101 location can be determined by a triangulation system such as a GPS, assisted GPS (A-GPS), Cell of Origin, wireless local area network triangulation, or other location extrapolation technologies. Standard GPS and A-GPS systems can use the one or more satellites 111 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module/sensor may also utilize multiple technologies to detect the location of the UE 101. GPS coordinates can provide finer detail as to the location of the UE 101. In another embodiment, the UE 101 may utilize a local area network (e.g., WLAN) connection to determine the UE 101 location information, for example, from an Internet source (e.g., a service provider). It is also contemplated that one or more AR, VR, and/or MR applications may be used to render a virtual presentation associated with one or more users.

Although various embodiments are discussed with respect to gesture-based interaction with devices and transferring of contents, it is contemplated that embodiments of the approach described herein are applicable to any type of user interaction with various devices for initiating and/or completing various tasks. In one embodiment, the sensors may capture data that may indicate state of a sensor, state of a user device, state of a user or the user environment, and the like.

By way of example, the communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 may be any type of mobile terminal, fixed terminal, or portable terminal including a mobile handset, station, unit, device, healthcare diagnostic and testing devices, product testing devices, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, TV receiver, radio broadcast receiver, electronic book device, game device, or any combination thereof, including the accessories and peripherals of these devices, or any combination thereof. It is also contemplated that the UEs can support any type of interface to the user (such as “wearable” circuitry, etc.). Further, the UEs 101 may include various sensors for collecting data associated with a vehicle, a user, a user's environment, and/or with a UE 101, for example, the sensors may determine and/or capture audio, video, images, atmospheric conditions, device location, user mood, ambient lighting, user physiological information, device movement speed and direction, and the like.

By way of example, the UEs 101, the service provider 105, the content providers 107, and the processing platform 109 may communicate with each other and the other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, one or more entities of the system 100 may interact according to a client-server model with the applications 103 and/or the DC module 115 of the UE 101. According to the client-server model, a client process sends a message including a request to a server process, and the server process responds by providing a service (e.g., context-based grouping, social networking, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

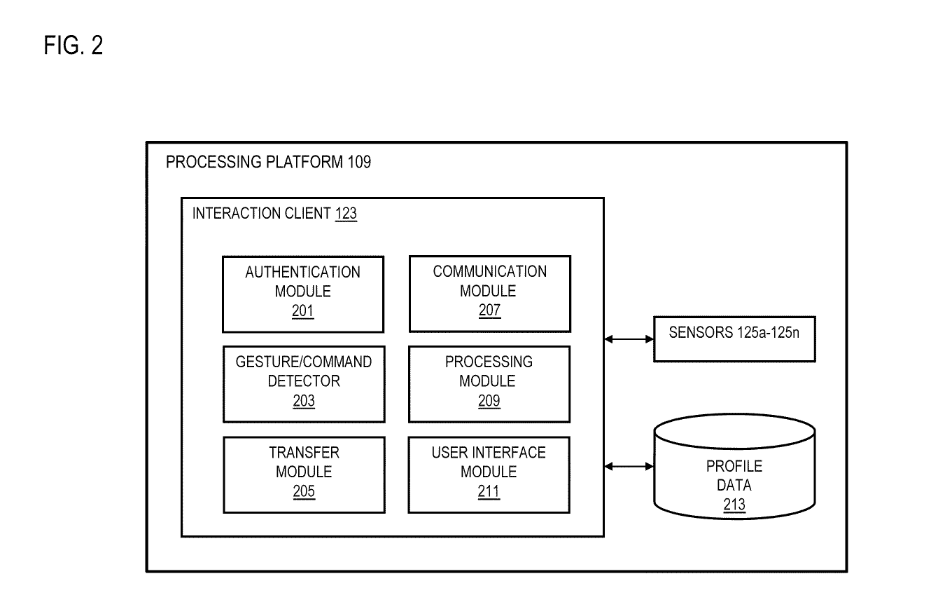

FIG. 2 is a diagram of the components of a processing platform, according to an embodiment. By way of example, the processing platform 109 includes one or more components for enabling gesture-based interaction with devices and transferring of contents among a plurality of devices. As previously noted, one or more portions of the processing platform 109 may be implemented in a UE 101, for example, in a TV set, in a computer, in a gaming console, in a tablet, and the like. It is contemplated that the functions of these components may be combined in one or more components or performed by other components of equivalent functionality. In this embodiment, the processing platform 109 includes the interaction client 123, the sensors 125, and profile data 213. In one embodiment, the interaction client 123 includes an authentication module 201, a gesture/command detector 203, a transfer module 205, a communication module 207, a processing module 209, and a user interface module 211.

In addition, the processing platform 109 may be configured to maintain various profile data at database 213, where profile data associated with one or more users and/or UEs 101 may be stored and utilized. For example, a user profile may include user information, user preferences, one or more UEs 101 associated with the user, communication channel preferences, various gestures utilized by a user, and the like.

In one embodiment, an authentication module 201 authenticates users and UEs 101 for interaction with one or more UEs 101. By way of example, the authentication module 201 enables a user to configure a UE 101 for affecting the transferring of contents and/or information (contents) among a plurality of UEs 101, for example, one or more sources and one or more targets. The authentication module 201 may operate in conjunction with the gesture/command detector 203 for detecting and determining one or more gestures and/or commands by one or more users. Further, the authentication module 201 may further operate in connection with the user interface module 211 for causing rendering of an interface for receiving user input regarding transferring of the contents among the UEs 101. In addition, the authentication module 201 enables the establishing of profile data 213 for configuring various settings, tolerances, reactions and preferences of the user and/or a UE 101. Preferences and settings information can be referenced to a specific user, user equipment, or combination thereof. The profile data 213 may also facilitate one or more rights and permissions for permitting access to a data source.

In one embodiment, the gesture/command detector 203 operates in connection with various sensors of the UEs 101 to initiate transferring of the contents among the UEs 101. In various scenarios, the contents may be presented on a UE 101 display as video, images, audio, textual information, and the like, wherein a user may utilize a gesture to indicate and select one or more content items for transferring from one UE 101 to another UE 101. It is contemplated as well that the gesture/command detector 203 may detect audio command for effectuating the transfer of the contents. In various embodiments, the gesture/command detector 203 may utilize one or more algorithms, for example image or audio algorithms, to analyze and determine the gestures and/or commands. Alternatively, the gesture/command detector 203 may operate with the user interface module 211 to render various keyword selection options to a display of an interacting device to further determine a gesture and/or command. The gesture/command detector 203 may also be configured to enable user customization of various gestures and commands for representing various functions at a UE 101. It is noted that the gesture/command detector 203 operates in connection with the user interface module 211 to enable the presentment of a configuration interface for defining various user preferences and settings. In one embodiment, the gesture/command detector 203 may detect via one or more sensors (e.g., camera, IR, etc.) a user's gestures (hand/finger movements in the air, etc.) on a surface (e.g., horizontal, vertical, etc.), facial expressions, and the like to represent various commands.

In one embodiment, the transfer module 205 facilitates transfer of the contents from one or more UE 101 sources to one or more UE 101 targets based on the established selection criteria 213. By way of example, the transfer module 205 processes the selection criteria as processed by the gesture/command detector 203. In one embodiment, the transfer module works in connection with the communication module 207 for causing the transfer of the selected contents to one or more UEs 101.

In one embodiment, a communication module 207 enables communication among the UEs 101 via one or more proximity-based communication channels (e.g., Bluetooth®, WLAN, etc.) and/or via a network based (e.g., cellular) session over the communication network 113. By way of example, the communication module 207 executes various protocols and data sharing techniques for enabling collaborative execution between UEs 101 (e.g., mobile devices, laptops, smartphones, TV sets, tablet computers, desktop computers, etc.) via the communication network 113.

The gesture/command detector 203 is also configured to operate in connection with a processing module 209. The processing module 209 may translate an area indicated by a user gesture and determine one or more areas on a UE 101 display and cause a selection of contents presented in the one or more areas at the time when the user gesture was detected and determined. For example, a user points to an area of a computer display where there is an image of a coffee mug presented, wherein the gesture/command detector 203 determines that the user is pointing in the direction of the coffee mug in the display and the processing module 209 determines the area on the display and the content (coffee mug) that is/was displayed in the display area when the user pointed at the display. By way of example, the processing module 209 may receive input from the gesture/command detector 203 and/or one or more sensors to provide coordinate information (e.g., in x, y, and z directions) of an area indicated by a user gesture for translating to an area on a display of a UE 101. In one embodiment, processing platform 209 determines the contents at a UE 101 for transferring to one or more other UEs 101.

In one embodiment, the user interface module 211 enables presentment of a graphical user interface for facilitating transfer and reception of the contents at the UEs 101. By way of example, the user interface module 211 generates the interface in response to application programming interfaces (APIs) or other function calls corresponding to the browser application or web portal application of the UEs 101. In one embodiment, the UI 211 may utilize various UI technologies available on a UE 101 for interfacing with the user. For example, a touch sensitive display, a detection field (e.g., capacitive, electromagnetic, etc.) on one or more sides of a UE 101, and the like. It is noted that the user interface module 211 may operate in accordance with various operating system environments for supporting the rendering of one or more representations of the contents.

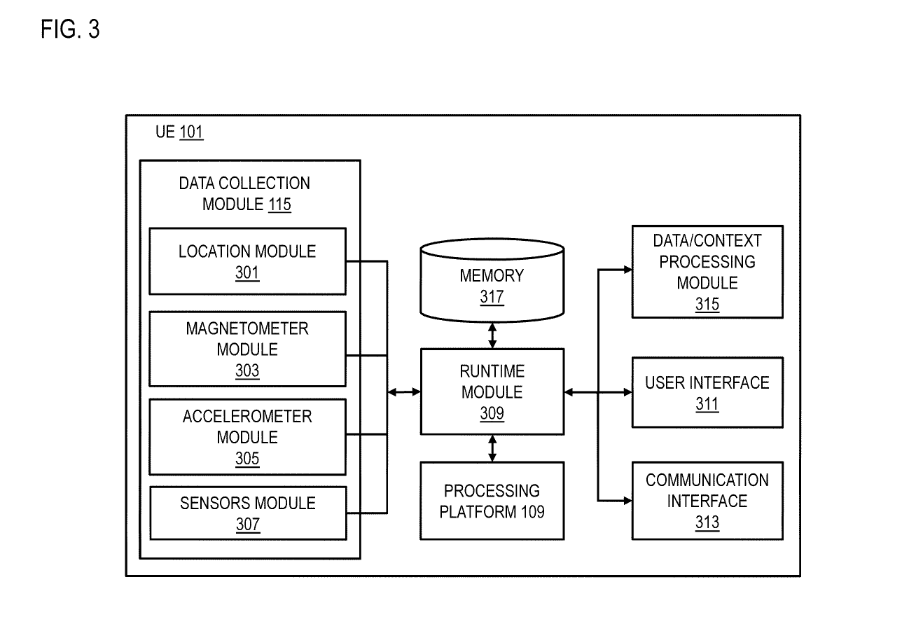

FIG. 3 is a diagram of the components of a user equipment capable of gesture-based interaction with devices and transferring of contents among a plurality of devices, according to an embodiment. By way of example, a UE 101 includes one or more components for detecting and/or analyzing sensor data to determine a user gesture, movement, activity, etc. for effectuating interaction and/or transferring of contents. It is contemplated that the functions of these components may be combined in one or more components or performed by other components of equivalent functionality. In this embodiment, the UE 101 includes a data collection module 115 that may include one or more location modules 301, magnetometer modules 303, accelerometer modules 305, and sensors modules 307. Further, the UE 101 may also include a runtime module 309 to coordinate the use of other components of the UE 101, a user interface 311, a communication interface 313, a data/context processing module 315, a memory 317, and a processing platform 109. The applications 103 of the UE 101 can execute on the runtime module 309 utilizing the components of the UE 101.

The location module 301 can determine a user's location, for example, via location of a UE 101. The user's location can be determined by a triangulation system such as GPS, assisted GPS (A-GPS), Cell of Origin, or other location extrapolation technologies. Standard GPS and A-GPS systems can use satellites 111 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The authentication module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 317 and are available to the processing platform 109, the service provider 105, and/or to other entities of the system 100 via the communication interface 313. Moreover, in certain embodiments, the GPS coordinates can include an altitude to provide a height. In other embodiments, the altitude can be determined using another type of altimeter. In certain embodiments, the location module 301 can be a means for determining a location of the UE 101, an image, or used to associate an object in view with a location.

The magnetometer module 303 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 317, made available to other modules and/or applications 103 of the UE 101, and/or transmitted via the communication interface 313 to one or more entities of the system 100.

The accelerometer module 305 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 305 can determine the angle the UE 101 is pointed as compared to Earth's gravity. In certain embodiments, the magnetometer module 303 and accelerometer module 305 can be means for ascertaining a perspective of a user. This perspective information may be stored in the memory 317, made available to other modules and/or applications 103 of the UE 101, and/or sent to one or more entities of the system 100.

In various embodiments, the sensors module 307 may include various sensors for detecting and/or capturing data associated with the user and/or the UE 101. For example, the sensors module 307 may include sensors for capturing environmental (e.g., atmospheric) conditions, audio, video, images, location information, temperature, user physiological data, user mood (e.g., hungry, angry, tired, etc.), user interactions with the UEs 101, and the like. In certain embodiments, information collected from and/or by the data collection module 115 can be retrieved by the runtime module 309, stored in memory 317, made available to other modules and/or applications 103 of the UE 101, and/or sent to one or more entities of the system 100.

The UI 311 can include various methods of communication. For example, the user interface 311 can have outputs including a visual component (e.g., a screen), an audio component, a physical component (e.g., vibrations), and other methods of communication. User interface can include a touch-screen interface, a detecting/sensitivity-field around one or more sides, a scroll-and-click interface, a button interface, a microphone, etc. Input can be via one or more methods such as voice input, textual input, typed input, typed touch-screen input, other touch-enabled input, etc.

In one embodiment, the communication interface 313 can be used to communicate with one or more entities of the system 100. Certain communications can be via methods such as an internet protocol, messaging (e.g., SMS, MMS, etc.), Bluetooth®, NFC, IR, or any other communication method directly among the UEs 101 and/or via the communication network 113. In some examples, the UE 101 can transfer contents associated with a UE 101 to one or more other UEs 101.

The data/context processing module 315 may be utilized in determining context information from the data collection module 115 and/or applications 103 executing on the runtime module 309. For example, it can determine user activity, content consumption, application and/or service utilization, user information, type of information included in the data, information that may be inferred from the data, and the like. The data may be shared with the applications 103, and/or caused to be transmitted, via the communication interface 313, to the service provider 105 and/or to other entities of the system 100. The data/context processing module 315 may additionally be utilized as a means for determining information related to the user, various data, the UEs 101, and the like. Further, data/context processing module 315, for instance, may manage (e.g., organizes) the collected data based on general characteristics, rules, logic, algorithms, instructions, etc. associated with the data. In certain embodiments, the data/context processing module 315 can infer higher level context information from the context data such as favorite contents, significant places, common activities, interests in products and services, etc.

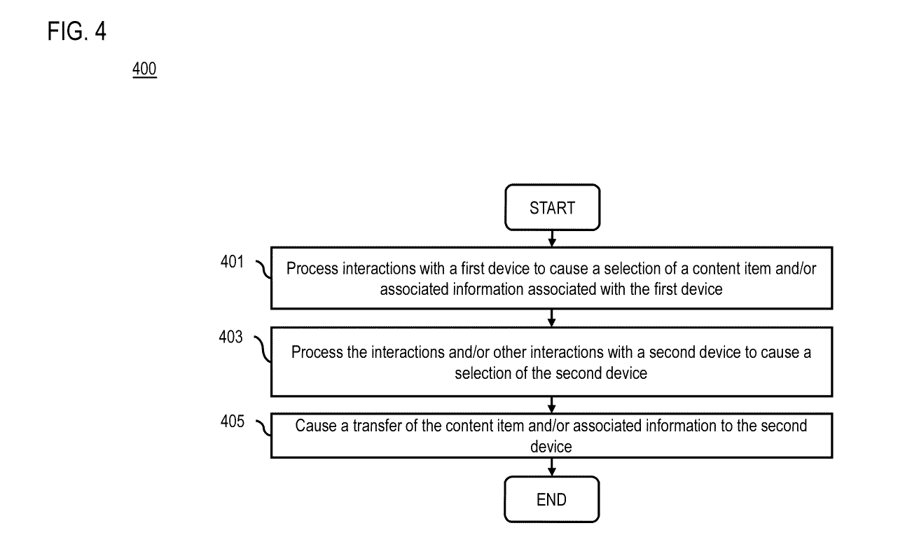

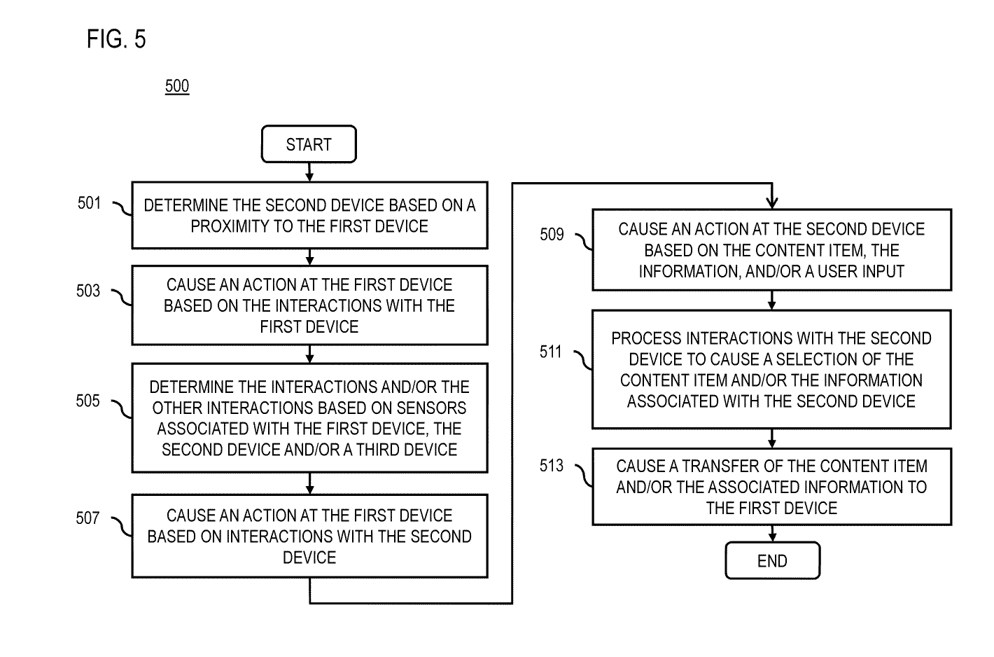

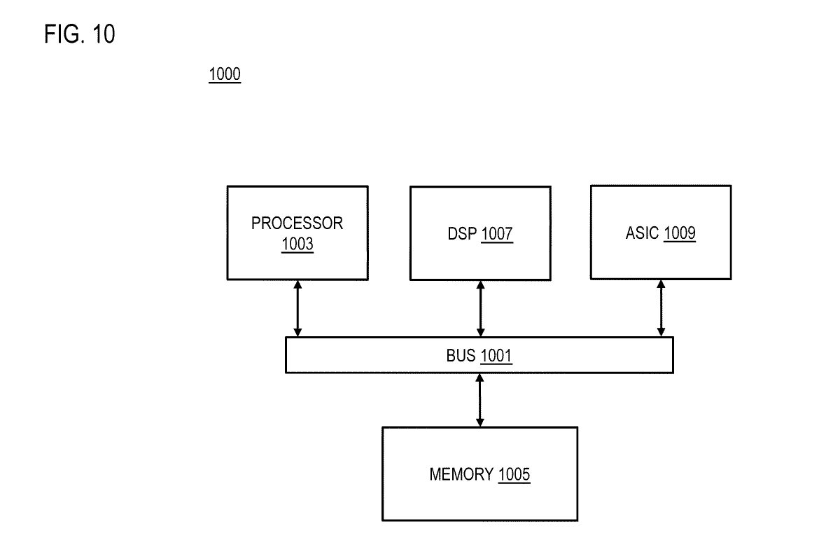

FIGS. 4 and 5 illustrate flowcharts of various processes for, at least, a user gesture-based interaction with devices and transferring of contents among a plurality of devices, according to various embodiments. In various embodiments, processing platform 109 and/or the DC module 115 may perform one or more portions of the processes 400 and 500, which may be implemented in, for instance, a chip set including a processor and a memory as shown in FIG. 10. As such, the processing platform 109 and/or the DC module 115 can provide means for accomplishing various parts of the process 400 and 500 as well as means for accomplishing other processes in conjunction with other components of the system 100. Throughout these processes, the processing platform 109 and/or the DC module 115 may be referred to as completing various portions of the processes 400 and 500, however, it is understood that other components of the system 100 can perform some of and/or all of the process steps. Further, for clarity in discussing the 400 and 500 processes, the processing platform 109 is referred to as completing various steps of said processes.

In step 401 of the FIG. 4, the processing platform 109 may process and/or facilitate a processing of one or more interactions with at least one first device to cause, at least in part, a selection of at least one content item, one or more information items associated with the at least one content item, or a combination thereof associated with the at least one first device. In one embodiment, the one or more interactions, the one or more other interactions, or a combination thereof include, at least in part, one or more gesture-based interactions. In one embodiment, a first UE 101 may include and utilize one or more sensors (e.g., camera, microphones, IR, etc.) to detect one or more gestures from one or more users in proximity of the UE 101. For example, a TV set may include a camera (e.g., forward looking, on the same side as the display), which can detect movements, hand gestures, facial impressions, and the like of a nearby user, which may be interacting with the TV set. Further, the UE 101 may determine from the user gestures, for example, that the user is pointing to a certain location on the display of the UE 101. For example, the UE 101 may utilize imaging data (e.g., in x-y-z coordinates) from the camera to determine location of the user in a room and further translate and determine where on the TV display is the user pointing to as a selection area. Furthermore, the UE 101 may determine contents that may be displayed in the selection area on the UE 101 display. For example, the user may be pointing to an image of a car displayed on the TV where the user pointed at for selecting the image of the care car as a selected content item. In various embodiments, one or more UEs 101, one or more sensors, one or more other systems, and the like may function and interact together to capture and determine the imaging data, the location data, the user gestures, user movements, and the like. In one embodiment, the system 100 may substantially simultaneously determine one or more simultaneous gestures and interactions from one or a plurality of users. In one embodiment, the system 100 may substantially simultaneously determine a first gesture for interaction with a first device and one or more other gestures for interaction with one or more other devices. For example, a first UE 101 may determine a gesture by a user where the user interacts with the first UE 101, and a second UE 101 may determine a simultaneous second gesture by the user for interacting with the second device. In one example, the first device may determine a simultaneous first gesture (e.g., by the user's left hand) and a second gesture (e.g., by the user's right hand), where the first gesture may be to interact with the first device for selecting a content item therein and the second gesture may be to transfer the selected content item to a second device. In one embodiment, the system 100 may substantially simultaneously determine a plurality of simultaneous gestures by a plurality of users for interacting with a plurality of devices.

In step 403 the processing platform 109 may process and/or facilitate a processing of the one or more interactions, one or more other interactions with at least one second device, or a combination thereof to cause, at least in part, a selection of the at least one second device. In one embodiment, one or more second UEs 101 may utilize one or more sensors to detect and determine one or more gestures of a user for selecting and/or interacting with the one or more second UEs 101. For example, a second UE 101 may utilize an onboard camera sensor to detect a gesture by a nearby user, which may indicate that the user wishes to select and interact with the second UE 101. In various examples, the user may use his hands and/or objects, to point, wave, make a grabbing gesture, make a fist, and the like, wherein each gesture may be detected by the system 100, which may determine that each gesture may represent one or more commands and/or action requests. In one embodiment, one or more other UEs 101 and/or sensors may detect and determine that the user is intending to select and interact with the second UE 101, wherein the other UEs 101 and/or sensors may communicate that information to the second UE 101. For example, a wall-mounted camera in a room may detect that a user is pointing to a nearby tablet device (e.g., on a coffee table), where the camera may transmit one or more messages to the tablet device indicating that the user is pointing to the tablet device.

In step 405 the processing platform 109 may cause, at least in part, a transfer of the at least one content item, the one or more information items associated with the at least one content item, or a combination thereof to the at least one second device. In one embodiment, a first UE 101 may determine that a user utilizes gestures (e.g., moving/pointing hand, finger, an object, a UE 101, etc.) to point to and select a content item presented on a display of a UE 101, wherein the user wishes to transfer the content item and/or information related to the content item to a second UE 101. In one embodiment, the first UE 101 may cause the transfer of the content item and/or the information to the second UE 101. In one embodiment, the user identifies the second UE 101 via one or more gestures and/or interactions with the first and/or the second UE 101. In one embodiment, the transfer is via one or more proximity communication channels, one or more network based communication channels, or a combination thereof. In various embodiments, the system 100 may utilize one or more communication channels for transferring the content and/or the information from a first device to one or more other devices, wherein the communication channels may include one or more proximity-based (e.g., device-to-device) and/or network-based channels.

In step 501 of the FIG. 5, the processing platform 109 may determine the at least one second device based, at least in part, on a proximity to the at least one first device. In one embodiment, one or more devices may determine presence of one or more other near-by devices via one or more proximity-based sensors (e.g., Bluetooth®, WLAN, etc.) and/or based on location information (e.g., GPS) of a device via a network service provider. For example, a first UE 101 may establish a proximity-based network (e.g., WLAN, Bluetooth®, etc.) in a room where other UEs 101 may join the network.

In step 503 the processing platform 109 may cause, at least in part, one or more actions at the at least one first device based, at least in part, on the one or more interactions with the at least one first device. In one embodiment, a UE 101 may determine to perform one or more actions based on one or more interactions caused by one or more users. For example, a UE 101 may cause execution of one or more applications on the UE 101 based on a gesture by a user. In one embodiment, a UE 101 may cause a selection (e.g., highlight) of contents, for example, information, images, videos, files, Internet links, and the like.

In step 505 the processing platform 109 may determine the one or more interactions, the one or more other interactions, or a combination thereof based, at least in part, on one or more sensors associated with the at least one first device, the at least one second device, at least one third device, or a combination thereof. In various embodiments, the UEs 101 may include various sensors, for example, cameras, microphones, IR detectors, electric field sensing, light detectors, and the like. In one embodiment, the at least one third device is associated with a spatial environment of the at least one first device, the at least one second device, or a combination thereof. In one instance, a first UE 101 and a second UE 101 may interact via one or more other devices (e.g., a third device), wherein the one or more other devices may be stationary and/or mobile devices in an area nearby to the first and/or the second UEs 101.

In step 507 the processing platform 109 may cause, at least in part, one or more actions at the at least one first device based, at least in part, on one or more interactions with the at least one second device. In one embodiment, a user may utilize a first UE 101 to interact with a second UE 101, wherein one or more actions on the first device may cause one or more actions on the second device. For example, a user may use a first UE 101 to control functions, programs, and applications on a second UE 101 (e.g., a TV set), wherein the UE 101 may provide various information associated with programs, applications, and functions available on the TV set.

In step 509 the processing platform 109 may cause, at least in part, one or more actions at the at least second device based, at least in part, on the at least one content item, the one or more information items, a user input, or a combination thereof. In one embodiment, a UE 101 which receives contents and information may cause execution of one or more applications that may be available locally on the UE 101 or available from a remote source (e.g., a service provider, a server, another UE 101, etc.) so that a user of the UE 101 may consume/utilize the content and/or the information. In one embodiment, the user may configure the UE 101 as to what applications may be utilized based on a content type. For example, if the content includes an Internet link, then a web browsing application may be executed to follow the link to a web target. In one embodiment, a UE 101, for example a first and/or a second device, may analyze the content to determine one or more suitable applications for a user to utilize, access, and/or consume the contents. For example, a second device receiving a content item may analyze the content to determine that the content is an image file, which may be viewed, edited, manipulated, etc. by one or more applications that may be available on the second device, via a service provider, and the like. In one embodiment, the UE 101 may receive the contents that include metadata which may indicate one or more applications and/or programs for use to consume the contents. In one embodiment, a UE 101 may cause to store the contents at a local and/or remote (e.g., cloud) storage device.

In step 511 the processing platform 109 may process and/or facilitate a processing of one or more interactions with the at least one second device to cause, at least in part, a selection of the at least one content item, the one or more information items associated with the at least one content item, or a combination thereof associated with the at least one second device. In one scenario, a user may interact with a second UE 101 (e.g., a tablet) to select and utilize one or more contents, for example, a user may modify, manipulate, consume, edit, etc. contents on the UE 101. In one embodiment, a UE 101 may detect a single gesture for interacting with the second device. In one embodiment, the gesture may include one or more gesture elements for interacting with one or more contents and/or devices.

In step 513 the processing platform 109 may cause, at least in part, a transfer of the at least one content item, the one or more information items associated with the at least one content item, or a combination thereof to the at least one first device. In one embodiment, a user may interact with the second UE 101 to select and transfer contents from the second UE 101 to one or more other UEs 101 (e.g., a TV set) wherein the contents may be available at the second UEs 101 and/or at a remote device (e.g., cloud storage site.) In one embodiment, the contents may be contents that the second UE 101 had received from a first UE 101, which the user of the second device may have utilized, consumed, edited, and the like.

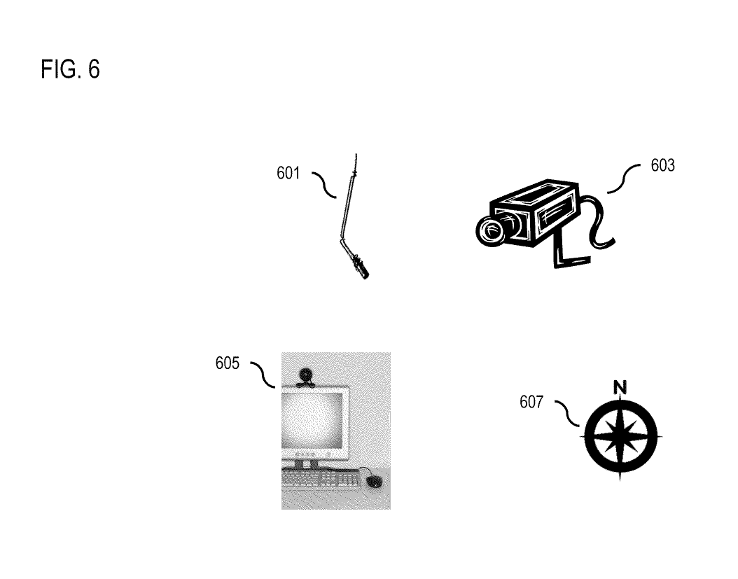

FIG. 6 illustrates various devices for detecting sensory data, according to an embodiment. In various embodiments, various sensors for detecting audio 601, imagery 603 and 605, and location/direction 607, a near-eye display to detect eye movement, other accessories (e.g., a laser-beam pen), and the like may be available on the UEs 101 (e.g., wearable), on one or more other devices, in a spatial proximity of one or more users and/or UEs 101 (e.g., in a room), in a vehicle, outside of a building, at a remote location, and the like. In various embodiments, multiple users may utilize various gestures, facial expressions, audio commands, and the like for interacting with a plurality of devices and sensors to effectuate selection and transfer of various contents among a plurality of the UEs 101.

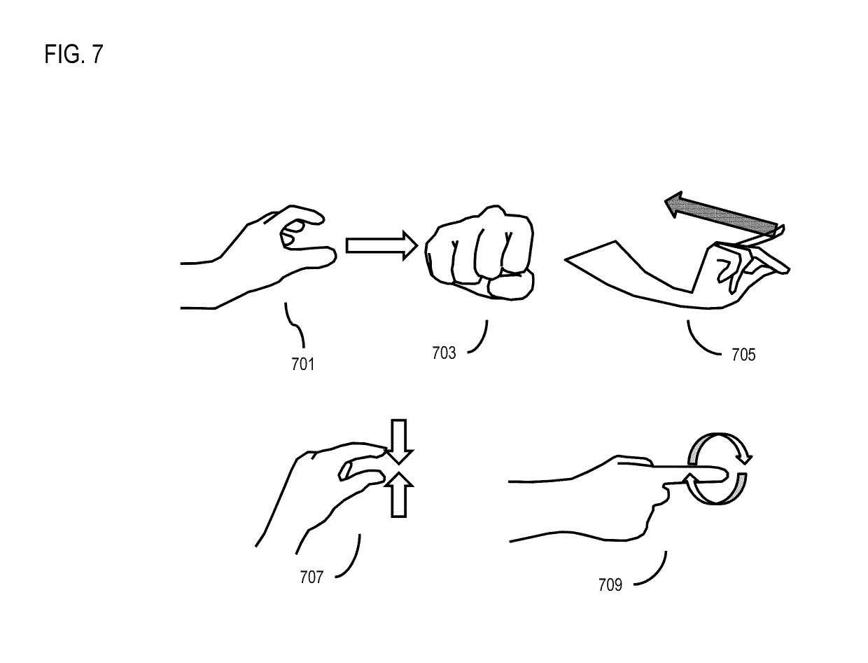

FIG. 7 illustrates example user gestures for interacting with various devices, according to various embodiments. In one embodiment, a gesture 701 (e.g., pointing, reaching, etc.) may indicate that a user is intending to select a content item displayed on a device and “grab” the content item with gesture 703 (e.g., closed fist.) In one embodiment, a gesture may include a user pointing and to a content item and indicate a transfer request via gesture 705 (e.g., point and snap fingers.) In one embodiment, a gesture 707 may include using fingers to point to and select content determined to be on a display between the fingers. In one embodiment, gesture 709 includes a user making a circular motion which may be determined to be around a content item displayed on a UE 101 display.

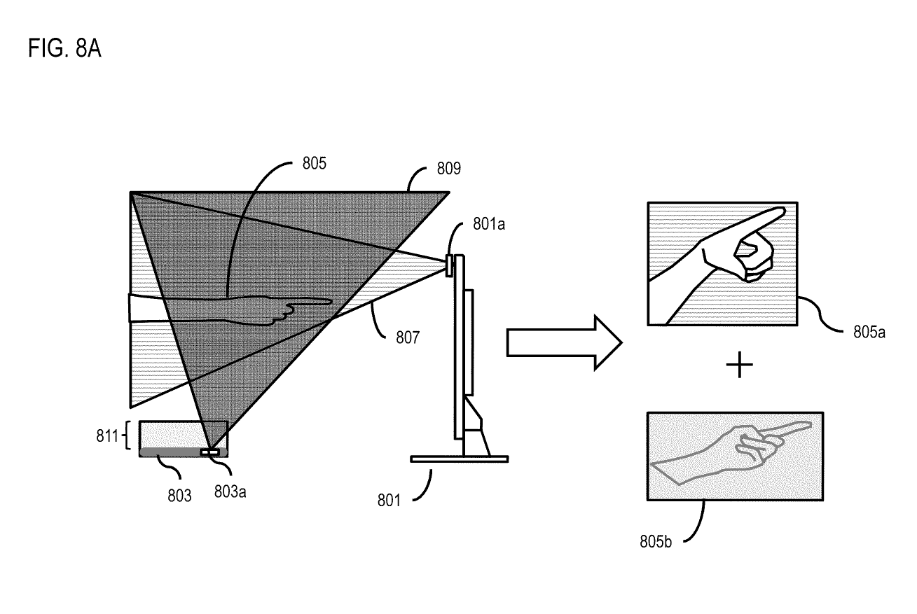

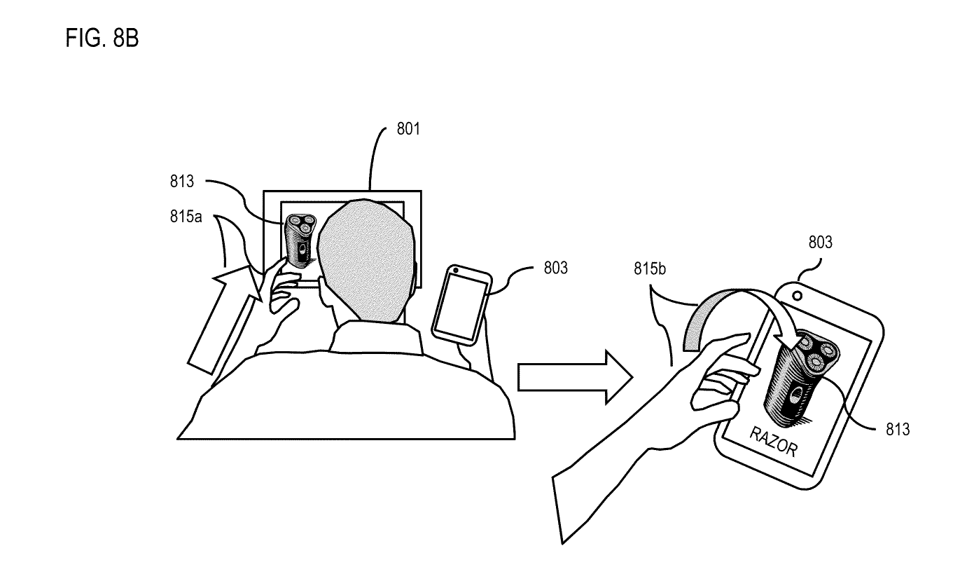

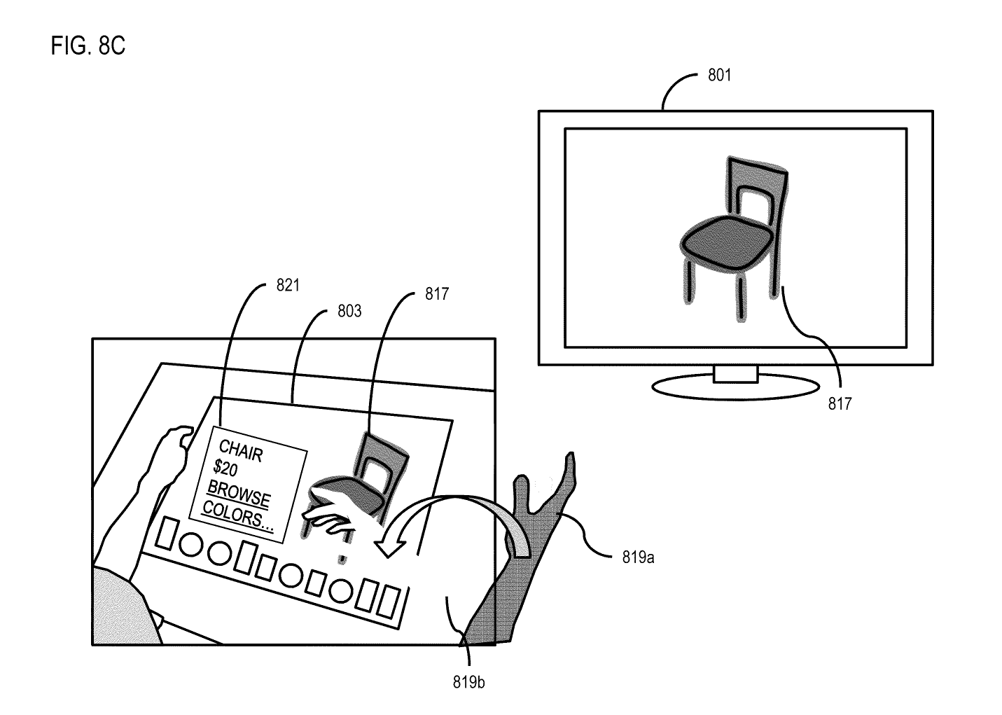

FIGS. 8A through 8C illustrate various user gesture-based interactions with various devices and contents presented on various devices, according to various embodiments.

FIG. 8A depicts devices 801 and 803, for example a TV set and a tablet, where they may detect a user gesture 805. In one embodiment, the device 801 may be a TV set that may comprise various sensors, including a camera 801a, where it may detect a gesture 805 via a scanning of a nearby spatial area 807, for example, to detect view 805a of the gesture 805. In one embodiment, the device 803 may utilize a sensor 803a (e.g., a camera, an IR detector, etc.) to detect the gesture 805, for example as view 805b of the gesture 805, via a spatial scan 809. In one embodiment, the two detected gestures 805a and 805b may be combined by the system 100 to obtain a more precise detection of the user gesture 805. In one embodiment, the device 803 may detect a gesture 805 for selecting the device 803 where the user may make the selection gesture toward the device 801 and then a gesture toward the device 803. Additionally, the device 803 may include a hover sensing field 811 above its display where if the user hand enters the hover sensing field 811 then the device 803 may cause one or more actions on the device 803; for example, control of a content item from the device 801 may be transferred to the device 803.

FIG. 8B depicts the devices 801 and 803 where the device 801, for example a TV set, displays content 813. In one scenario, a user makes gesture 815a to point to and select the content 813 and then gesture 815b to transfer the content 813 and any related information to the device 803. In FIG. 8C, depicts devices 801 and 803 where a user selects content 817 on the device 801 and makes gestures 819a to select the content 817 on the device 801 and gesture 819b to transfer the content 817 and any related information 821 to the device 803. In one embodiment, the device 801 and/or 803 may cause execution of the applications 103 on the device 801 and/or 803, wherein the applications 103 may be utilized to consume the content; for example, to view, listen, edit, etc. In one embodiment, the execution of the application 103 may be based, at least in part, on a content type, user history, user preferences, device configuration and the like.

The processes described herein for enabling gesture-based interaction with devices and transferring of contents may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

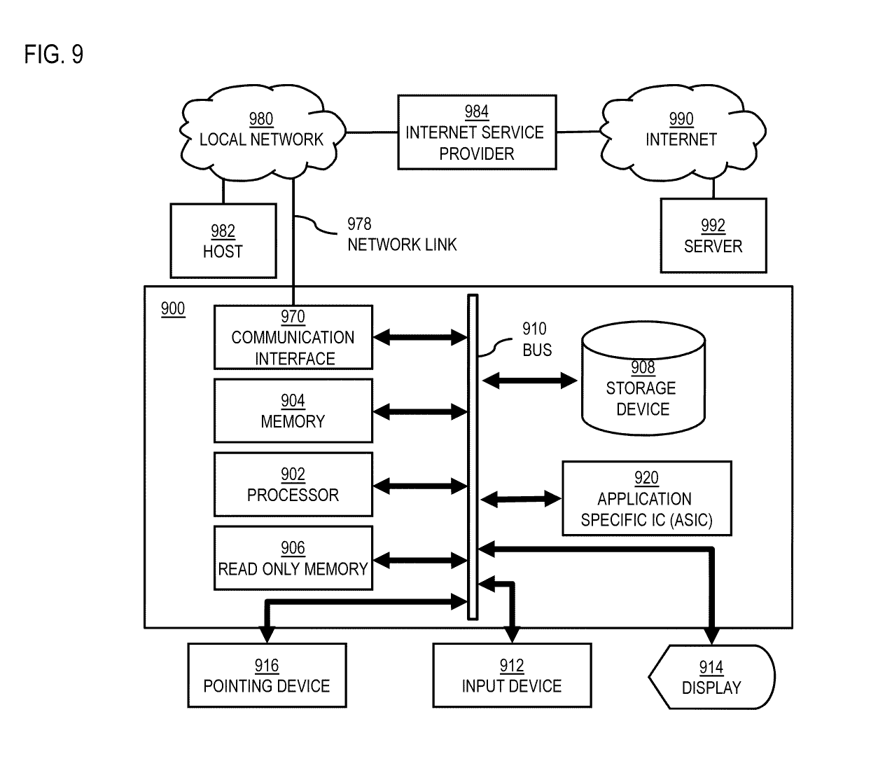

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to enable gesture-based interaction with devices and transferring of contents as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic, and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of enabling gesture-based interaction with devices and transferring of contents.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to enabling gesture-based interaction with devices and transferring of contents. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for enabling gesture-based interaction with devices and transferring of contents. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for enabling gesture-based interaction with devices and transferring of contents, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, which carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 113 for enabling gesture-based interaction with devices and transferring of contents.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to enable gesture-based interaction with devices and transferring of contents as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of enabling gesture-based interaction with devices and transferring of contents.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to enabling gesture-based interaction with devices and transferring of contents. The memory 1005 also stores the data associated with or generated by the execution of the inventive steps.

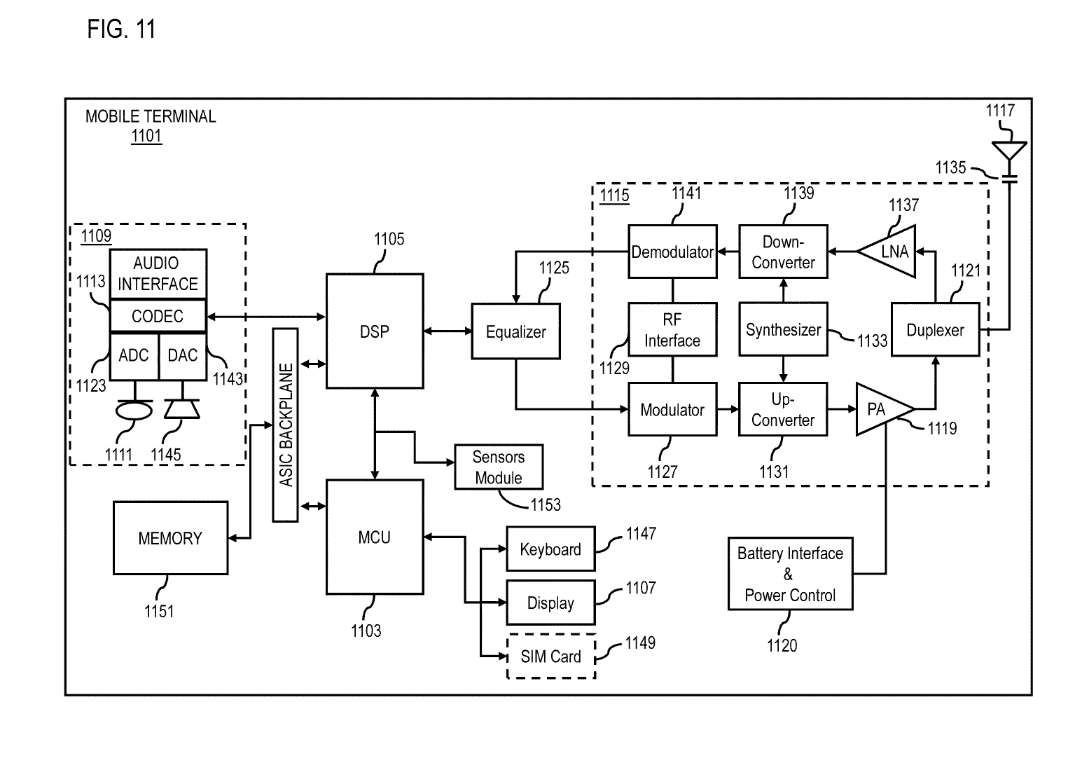

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of enabling gesture-based interaction with devices and transferring of contents. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of enabling gesture-based interaction with devices and transferring of contents. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairment that may occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to enable gesture-based interaction with devices and transferring of contents. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Additionally, sensors module 1153 may include various sensors, for instance, a location sensor, a speed sensor, an audio sensor, an image sensor, a brightness sensor, a biometrics sensor, various physiological sensors, a directional sensor, and the like, for capturing various data associated with the mobile terminal 1101 (e.g., a mobile phone), a user of the mobile terminal 1101, an environment of the mobile terminal 1101 and/or the user, or a combination thereof, wherein the data may be collected, processed, stored, and/or shared with one or more components and/or modules of the mobile terminal 1101 and/or with one or more entities external to the mobile terminal 1101.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a processing of one or more interactions with at least one first device to cause, at least in part, a selection of at least one content item, one or more information items associated with the at least one content item, or a combination thereof associated with the at least one first device;
a processing of the one or more interactions, one or more other interactions with at least one second device, or a combination thereof to cause, at least in part, a selection of the at least one second device; and
a transfer of the at least one content item, the one or more information items associated with the at least one content item, or a combination thereof to the at least one second device.

2. A method of claim 1, wherein the (1) data and/or (2) information and/or (3) at least one signal are further based, at least in part, on the following:
at least one determination of the at least one second device based, at least in part, on a proximity to the at least one first device.

3. A method of claim 2, wherein the (1) data and/or (2) information and/or (3) at least one signal are further based, at least in part, on the following:
one or more actions at the at least one first device based, at least in part, on the one or more interactions with the at least one first device.

4. A method of claim 1, wherein the transfer is via one or more proximity communication channels, one or more network based communication channels, or a combination thereof.

5. A method of claim 1, wherein the one or more interactions, the one or more other interactions, or a combination thereof include, at least in part, one or more gesture-based interactions.

6. A method of claim 1, wherein the (1) data and/or (2) information and/or (3) at least one signal are further based, at least in part, on the following:
at least one determination of the one or more interactions, the one or more other interactions, or a combination thereof based, at least in part, on one or more sensors associated with the at least one first device, the at least one second device, at least one third device, or a combination thereof.

7. A method of claim 6, wherein the at least one third device is associated with a spatial environment of the at least one first device, the at least one second device, or a combination thereof.

8. A method of claim 1, wherein the (1) data and/or (2) information and/or (3) at least one signal are further based, at least in part, on the following:
one or more actions at the at least one first device based, at least in part, on one or more interactions with the at least one second device.

9. A method of claim 1, wherein the (1) data and/or (2) information and/or (3) at least one signal are further based, at least in part, on the following:
one or more actions at the at least second device based, at least in part, on the at least one content item, the one or more information items, a user input, or a combination thereof.

10. A method of claim 1, wherein the (1) data and/or (2) information and/or (3) at least one signal are further based, at least in part, on the following:
a processing of one or more interactions with the at least one second device to cause, at least in part, a selection of the at least one content item, the one or more information items associated with the at least one content item, or a combination thereof associated with the at least one second device; and
a transfer of the at least one content item, the one or more information items associated with the at least one content item, or a combination thereof to the at least one first device.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more interactions with at least one first device to cause, at least in part, a selection of at least one content item, one or more information items associated with the at least one content item, or a combination thereof associated with the at least one first device;
process and/or facilitate a processing of the one or more interactions, one or more other interactions with at least one second device, or a combination thereof to cause, at least in part, a selection of the at least one second device; and
cause, at least in part, a transfer of the at least one content item, the one or more information items associated with the at least one content item, or a combination thereof to the at least one second device.

12. An apparatus of claim 11, wherein the apparatus is further caused to:
determine the at least one second device based, at least in part, on a proximity to the at least one first device.

13. An apparatus of claim 11, wherein the apparatus is further caused to:
cause, at least in part, one or more actions at the at least one first device based, at least in part, on the one or more interactions with the at least one first device.

14. An apparatus of claim 11, wherein the transfer is via one or more proximity communication channels, one or more network based communication channels, or a combination thereof.

15. An apparatus of claim 11, wherein the one or more interactions, the one or more other interactions, or a combination thereof include, at least in part, one or more gesture-based interactions.

16. An apparatus of claim 11, wherein the apparatus is further caused to:
determine the one or more interactions, the one or more other interactions, or a combination thereof based, at least in part, on one or more sensors associated with the at least one first device, the at least one second device, at least one third device, or a combination thereof.

17. An apparatus of claim 16, wherein the at least one third device is associated with a spatial environment of the at least one first device, the at least one second device, or a combination thereof.

18. An apparatus of claim 11, wherein the apparatus is further caused to:
cause, at least in part, one or more actions at the at least one first device based, at least in part, on one or more interactions with the at least one second device.

19. An apparatus of claim 11, wherein the apparatus is further caused to:
cause, at least in part, one or more actions at the at least second device based, at least in part, on the at least one content item, the one or more information items, a user input, or a combination thereof.

20. An apparatus of claim 11, wherein the apparatus is further caused to:
process and/or facilitate a processing of one or more interactions with the at least one second device to cause, at least in part, a selection of the at least one content item, the one or more information items associated with the at least one content item, or a combination thereof associated with the at least one second device; and
cause, at least in part, a transfer of the at least one content item, the one or more information items associated with the at least one content item, or a combination thereof to the at least one first device.

21.-48. (canceled)
